(19) United States
(12) Patent Application Publication
(10) Pub. No.: US 2005/0002672 A1
(43) Pub. Date: Jan. 6, 2005

(54) Optical transmission device

(75) Inventors: Yukiko Sakai, Yokohama (JP); Kazuto Imai, Yokohama (JP); Tsukasa Takahashi, Yokohama (JP); Hiroto Ikeda, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/803,875

(22) Filed: Mar. 19, 2004

(30) Foreign Application Priority Data
Jul. 1, 2003 (JP) 2003-270171

(51) Int. Cl. H04J 14/02

(52) U.S. Cl. 398/85; 398/79

(57) ABSTRACT

An optical transmission device which efficiently suppresses variations among loss levels in optical fiber transmission, and improves quality of optical transmission. A WDM port is connected to an optical transmission line, and functions as a port for transmission and reception of a wavelength-multiplexed signal. A wavelength multiplex/demultiplex unit has optical filters which are daisy-chain connected, and realize a loss characteristic weighted at respective wavelengths in correspondence with a wavelength-dependent loss characteristic of the optical transmission line. Each of the optical filters has a function of a band-pass filter and an identical insertion loss. The wavelength multiplex/demultiplex unit performs wavelength demultiplexing of a signal received through the WDM port, or wavelength multiplexing of signals to be outputted through the WDM port, so as to suppress differences among different channels in loss caused by transmission of a wavelength-multiplexed signal, and equalize loss levels in the different channels.

### BACKGROUND OF THE INVENTION

1) Field of the Invention

The present invention relates to an optical transmission device. In particular, the present invention relates to an optical transmission device which performs WDM (wavelength division multiplex) transmission of optical signals.

2) Description of the Related Art

In the fields of optical communication networks, there are demands for sophistication of services and expansion of service areas, and WDM is beginning to be widely used as an optical transmission technique. WDM is a technique in which signals in a plurality of channels are concurrently transmitted through a single optical fiber by multiplexing light having different wavelengths. In addition, with the rapid increase in communication traffic, the numbers of wavelengths to be used are increasing, and a kind of WDM called DWDM (Dense WDM) has been developed. In DWDM, high-density wavelength multiplexing is performed.

According to DWDM, up to approximately 180 wavelengths can be multiplexed. Therefore, when the transmission rate at each wavelength is 10 Gbps, superfast optical transmission of approximately 1.8 Tbps can be realized. However, since the wavelength range allocated to each wavelength channel is narrow, the control is complicated, elements constituting equipment for realizing DWDM are expensive. In addition, since the equipment for realizing DWDM is massive, DWDM is mainly used in backbone networks.

On the other hand, in recent years, another kind of WDM called CWDM (Coarse WDM) is receiving attention. In CWDM, low-density wavelength multiplexing is performed. According to CWDM, the number of wavelengths which can be multiplexed is as small as a dozen or so. Therefore, the precision required in wavelength setting can be relaxed by increasing wavelength gaps (coarsening the wavelength division), and the equipment for realizing CWDM is compact and inexpensive.

Thus, CWDM is currently expected to be a mainstream system in access networks for short-to-medium-distance (about 10 to 50 km) transmission using an existing optical fiber cable without a repeater.

FIG. 13 is a schematic diagram illustrating an example of wavelength allocation in DWDM, and FIG. 14 is a schematic diagram illustrating an example of wavelength allocation in CWDM. In each of FIGS. 13 and 14, the abscissa corresponds to the wavelength (nm), and the ordinate corresponds to signal level.

In the DWDM illustrated in FIG. 13, the wavelength gaps are about 0.4 to 0.8 nm, and several tens to one hundred and several tens of wavelengths are multiplexed in the band of 1.5 to 1.6 micrometers, where the signal bandwidth of each wavelength channel is narrow. In addition, in the CWDM illustrated in FIG. 14, the wavelength gaps are as great as about 20 nm, and wavelengths are multiplexed in the band of 1.3 to 1.6 micrometers, where the number of the wavelengths is as small as a dozen or so, and the signal bandwidth of each wavelength channel is broad.

On the other hand, in a conventional WDM technique (for example, as disclosed in Japanese Unexamined Patent Publication No. 10-148791, paragraph Nos. 0006 to 0026 and FIG. 1), two wavelength-multiplexed light beams, which are obtained by optical multiplexing using WDM couplers, are further optically multiplexed. In the technique, a first wavelength-multiplexed light beam outputted from a first WDM coupler is superimposed on a second wavelength-multiplexed light beam outputted from a second WDM coupler in such a manner that the wavelengths of the first wavelength-multiplexed light beam do not coincide with the wavelengths of the second wavelength-multiplexed light beam.

Since, in contrast to DWDM, the CWDM as described above does not require highly precise wavelength setting and complicated control of a wavelength stabilization circuit and the like, it is possible to reduce the system cost in the case of CWDM. However, since the wavelengths (channels) used in CWDM transmission are thinly dispersed over a wide wavelength range, the characteristics of optical transmission lines cause variations in loss among wavelength-multiplexed signals in different channels.

FIG. 15 is a graph indicating wavelength-dependent-loss (WDL) characteristics of optical transmission lines. In FIG. 15, wavelength-dependent loss characteristics of single-mode fibers (SMFs), which are normally used as optical fiber cables, are shown, the abscissa corresponds to the wavelength (nm), and the ordinate corresponds to the loss (dB/km).

In FIG. 15, the curve K1 shows a WDL of an SMF which causes a loss of 0.25 dB per km in transmission at the wavelength of 1,550 nm, and the curve K2 shows a WDL of an SMF which causes a loss of 0.3 dB per km in transmission at the wavelength of 1,550 nm. FIG. 15 shows that the difference between the maximum and the minimum of the loss in the wavelength range B1 used in DWDM is as small as about 0.005 dB in either of the curves K1 and K2.

FIG. 16 is a diagram indicating reception levels in different channels in DWDM transmission. In FIG. 16, the abscissa corresponds to the channel, and the ordinate corresponds to the reception level. As illustrated in FIG. 16, in the case of DWDM, there are substantially no variations among the loss levels in different channels. Therefore, receivers are not required to take account of the variations among the loss levels in different channels. That is, it is possible to satisfactorily receive signals in the different channels by a receiver which is configured based on the assumption that the reception levels in the different channels are identical.

In addition, optical amplifiers called erbium-doped-fiber amplifiers (EDFAs) are known as optical amplifiers for use in repeaters in DWDM transmission. In the EDFAs, an erbium (Er³⁺) doped optical fiber (EDF) is used as a medium for amplification, and optical signals are amplified by stimulated emission which occurs when excitation light is applied to the erbium doped optical fiber during transmission of the optical signals through the erbium doped optical fiber. The gain ranges of the EDFAs are almost included in the wavelength range B1. Therefore, in addition to the smallness of the variations among loss levels in different channels, the DWDM transmission has an advantage that large-capacity long-distance transmission is enabled when optical relay transmission is performed by using repeaters containing an EDFA.

On the other hand, FIG. 15 also shows that the difference between the maximum and the minimum of the loss in the wavelength range B2 used in CWDM is as large as about 0.07 dB in either of the curves K1 and K2.

FIG. 17 is a diagram indicating reception levels in different channels in CWDM transmission. In FIG. 17, the abscissa corresponds to the channel, and the ordinate corresponds to the reception levels. As illustrated in FIG. 17, since CWDM transmission is performed through a small number of channels arranged in the wide wavelength range B2, variations among loss levels in different channels become great. Therefore, receivers in CWDM are required to consider the variations among loss levels in different channels.

In the conventional CWDM systems, a plurality of receivers which receive signals in different channels are prepared, and reception levels in the receivers are individually set (i.e., dynamic ranges of the receivers are individually adjusted), since loss levels in the respective channels are different. Therefore, the device size and cost increase, and the maintenance efficiency is low.

In addition, although Japanese Unexamined Patent Publication No. 10-148791 discloses that wavelength-multiplexed signals are transmitted with the reduced wavelength gaps, variations among the loss levels in different channels after signal transmission are not considered.

### SUMMARY OF THE INVENTION

The present invention is made in view of the above problems, and the object of the present invention is to provide an optical transmission device which efficiently suppresses variations in loss levels in optical fiber transmission, and improves quality in optical transmission.

In order to accomplish the above object, an optical transmission device for performing transmission of an optical signal is provided. The optical transmission device comprises: a WDM port as a port for transmission and reception of a wavelength-multiplexed signal; and a wavelength multiplex/demultiplex unit which has a loss characteristic compensating for a wavelength-dependent loss characteristic of an optical transmission line, performs at least one of wavelength demultiplexing of a signal received through the WDM port and wavelength multiplexing for outputting a signal through the WDM port, and suppresses differences among different channels in loss caused by transmission of a wavelength-multiplexed signal so as to equalize loss levels in the different channels in the wavelength-multiplexed signal.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a diagram illustrating the principle of an optical transmission device according to the present invention;

FIG. 2 is a diagram illustrating a construction of a wavelength multiplex/demultiplex unit;

FIG. 3 is a diagram illustrating an arrangement of optical filters;

FIG. 4 is a diagram illustrating a loss characteristic which compensates for a WDL of an optical transmission line;

FIG. 5 is a diagram illustrating an arrangement for a plurality of channels based on consideration of insertion loss;

FIG. 6 is a diagram indicating correspondences between port numbers of optical filters and channels;

FIG. 7 is a diagram illustrating a construction in which all ports are used for wavelength multiplexing;

FIG. 8 is a diagram illustrating a construction in which ports are divided into two groups for performing wavelength demultiplexing and wavelength multiplexing;

FIG. 9 is a diagram illustrating a construction of an optical transmission system;

FIG. 10 is a diagram indicating a loss compensation map;

FIG. 11 is a diagram indicating a loss compensation map;

FIG. 12 is a diagram indicating a loss compensation map;

FIG. 13 is a schematic diagram illustrating an example of wavelength allocation in DWDM;

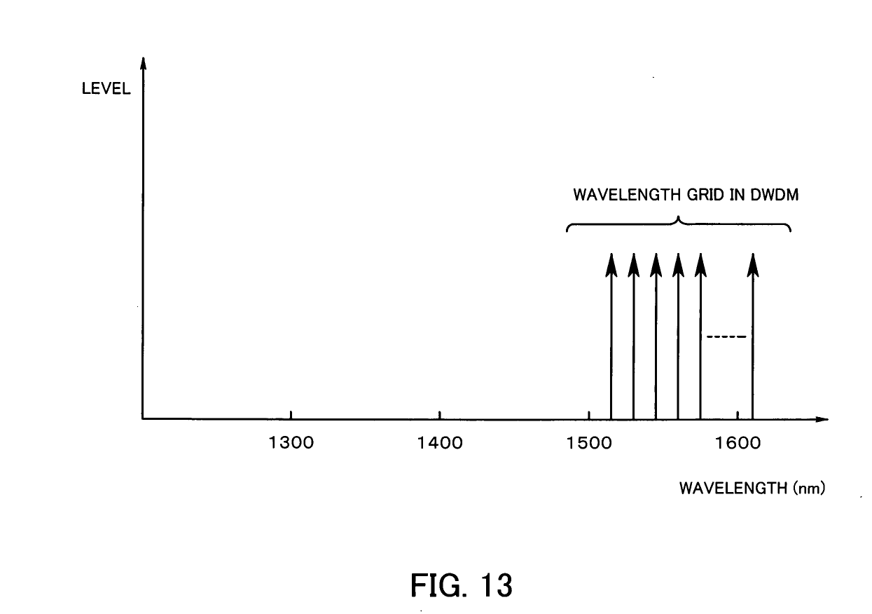

FIG. 14 is a schematic diagram illustrating an example of wavelength allocation in CWDM;

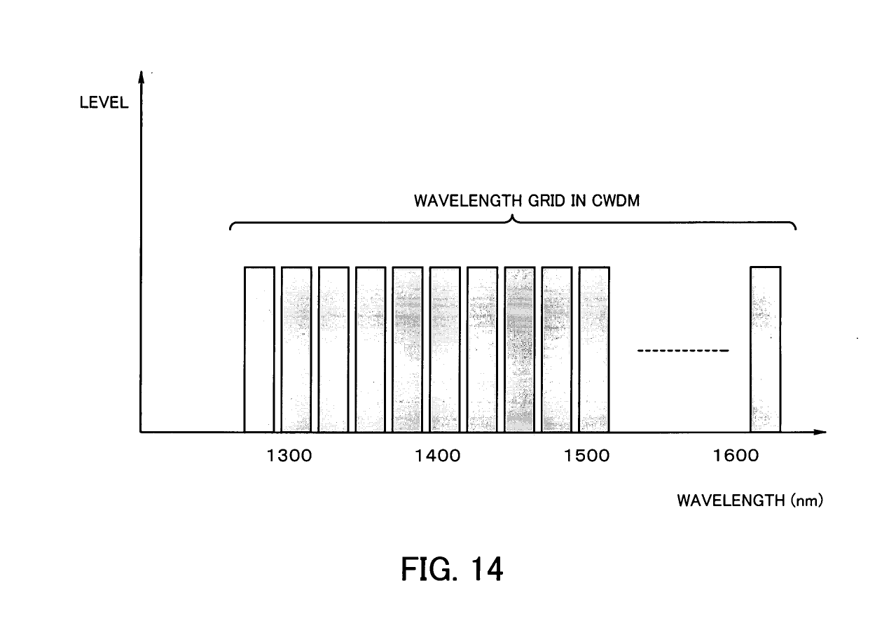

FIG. 15 is a graph indicating wavelength-dependent-loss (WDL) characteristics of optical transmission lines;

FIG. 16 is a diagram indicating reception levels in different channels in DWDM transmission; and

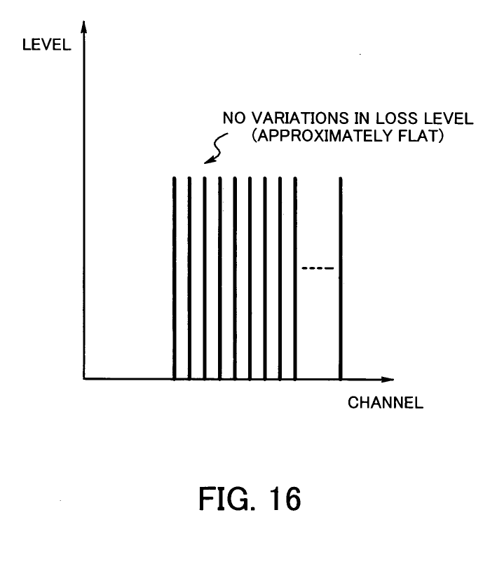

FIG. 17 is a diagram indicating reception levels in different channels in CWDM transmission.

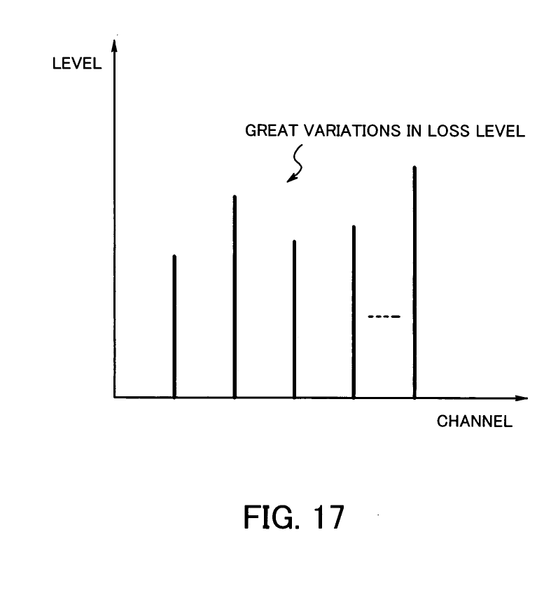

### DESCRIPTION OF THE PREFERRED EMBODIMENTS

Embodiments of the present invention are explained below with reference to drawings.

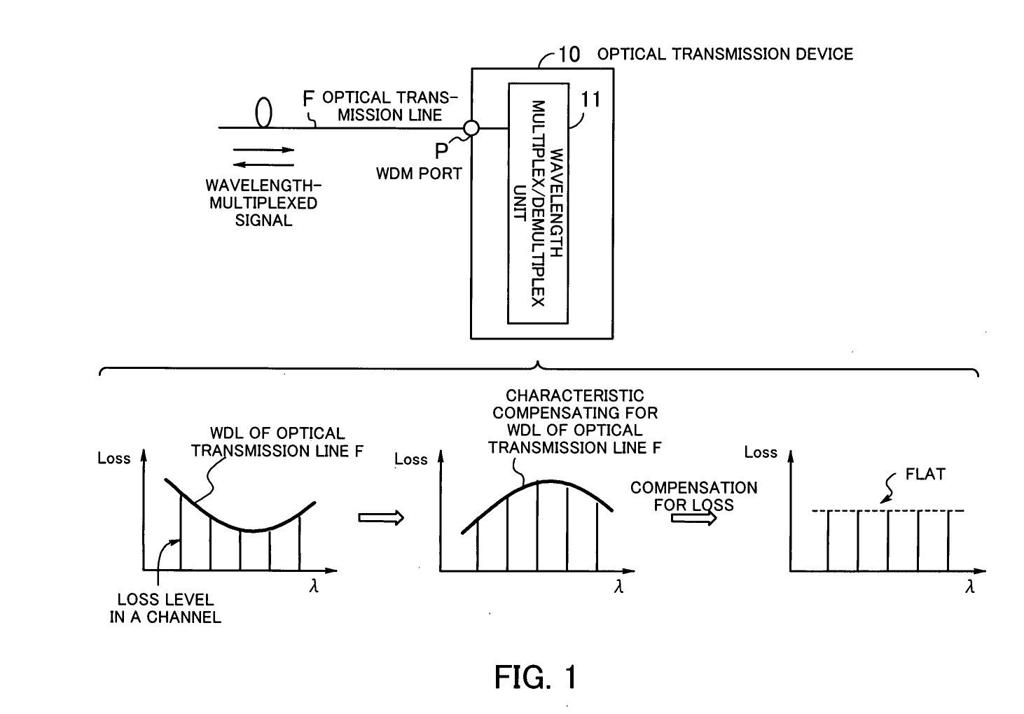

FIG. 1 is a diagram illustrating the principle of an optical transmission device according to the present invention. The optical transmission device 10 according to the present invention is used in a system for performing communication through a plurality of channels arranged in a wide wavelength range, and transmits WDM optical signals. In the following explanations, CWDM is taken as an example.

In the optical transmission device 10, a WDM port P is connected to an optical transmission line F, and functions as a port for transmission and reception of wavelength-multiplexed signals. The wavelength multiplex/demultiplex unit (wavelength multiplex/demultiplex coupler) 11 performs at least one of wavelength separation (demultiplexing) of signals received through the WDM port and wavelength multiplexing for outputting signals from the WDM port P. The wavelength multiplex/demultiplex unit 11 has a loss characteristic (or transmittance characteristic) which compensates for a wavelength-dependent-loss (WDL) characteristic of the optical transmission line F so that differences among loss levels in different channels after transmission of a wavelength-multiplexed signal are suppressed, and identical reception levels are set to the channels.

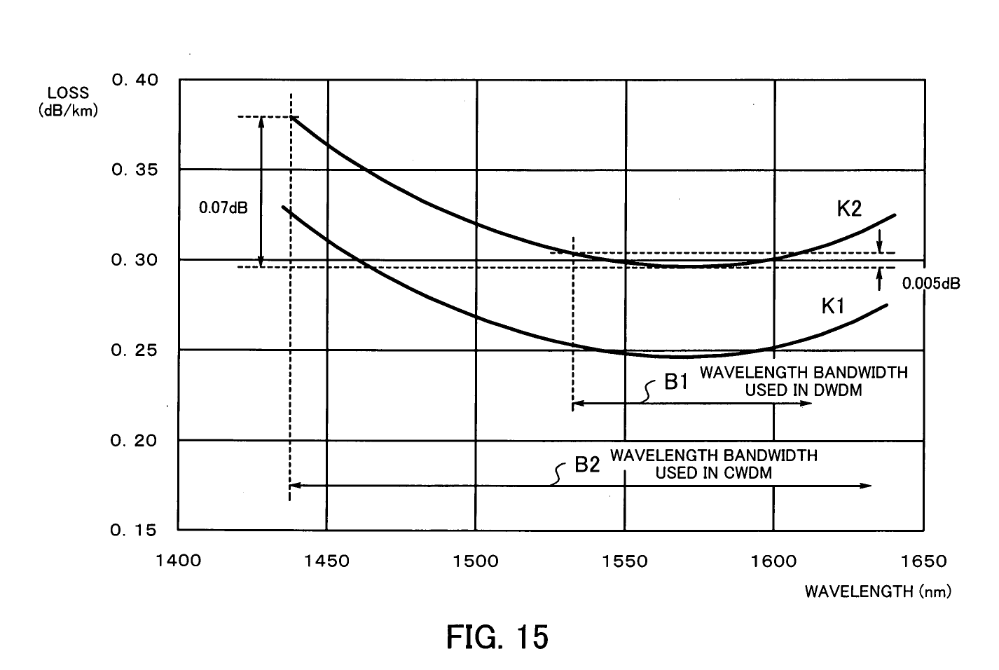

Consider a case where the wavelength multiplex/demultiplex unit 11 receives and demultiplexes a wavelength-multiplexed signal transmitted through the optical transmission line F. Since the optical transmission line F realized by an SMF has a WDL as indicated in FIG. 15, when channels are arranged by a transmitter in a wide wavelength range, differences among loss levels in the channels become prominent at a receiver after transmission of a signal. Therefore, the wavelength multiplex/demultiplex unit 11 is arranged to have a loss characteristic (or transmittance characteristic) which compensates for the wavelength-dependent-loss (WDL) characteristic of the optical transmission line F so that the differences among the loss levels in the channels are cancelled out after transmission of a signal by the loss characteristic of the wavelength multiplex/demultiplex unit 11 when the wavelength demultiplexing is performed. Thus, it is possible to equalize the reception levels of the demultiplexed signals in the different channels.

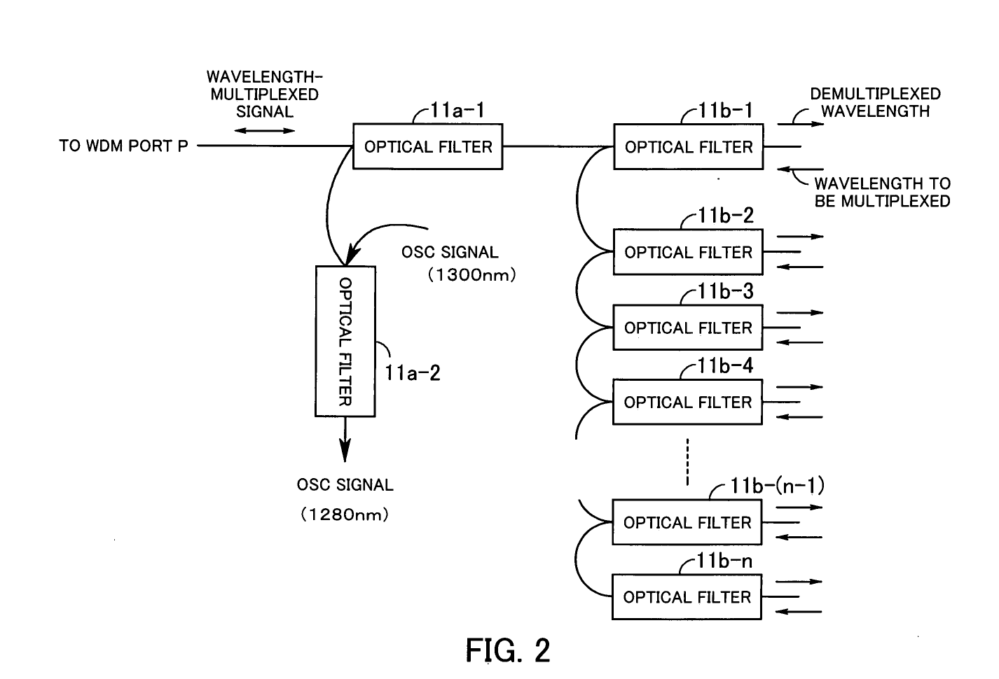

Next, a construction and operations of the wavelength multiplex/demultiplex unit 11 are explained below. FIG. 2 is a diagram illustrating a construction of the wavelength multiplex/demultiplex unit 11. As illustrated in FIG. 2, the wavelength multiplex/demultiplex unit 11 comprises optical filters 11a-1, 11a-2, and 11b-1 through 11b-n. The optical filters 11a-1 and 11a-2 perform extraction and insertion of OSC (optical supervisory channel) signals, and the optical filters 11b-1 through 11b-n perform multiplexing and demultiplexing of main signals. The OSC signals are optical signals used for condition monitoring and setting for administration of the system. In the following explanations, a case wherein the OSC wavelength belongs to 1.3 μm band is taken as an example.

The optical filters 11b-1 through 11b-n are daisy-chain connected. Each of the optical filters 11b-1 through 11b-n has an individual function of a band-pass filter and an identical insertion loss. In addition, a weighted loss characteristic corresponding to and compensating for the loss characteristic of the optical transmission line F at the respective wavelengths is set in the optical filters 11b-1 through 11b-n.

The operations for wavelength demultiplexing (wavelength separation) are explained below. In the following explanations, it is assumed that a transmitter transmits a wavelength-multiplexed signal containing main signals in n channels arranged in a wavelength range used in CWDM and an OSC signal arranged on the shorter wavelength side of the main signals (e.g., at the wavelength of 1,310 nm).

The wavelength-multiplexed signal received through the WDM port P first enters the optical filter 11a-1. The optical filter 11a-1 has a function of a low-pass filter, reflects the OSC signal, and allows the main signals pass through the optical filter 11a-1. (Alternatively, when the OSC signal is arranged on the longer wavelength side of the main signals, the optical filter 11a-i has a function of a high-pass filter.) The reflected OSC signal is sent to the optical filter 11a-2, and the main signals which have passed through the optical filter 11a-1 are sent to the optical filter 11b-1. The optical filter 11a-2 allows the OSC signal pass through the optical filter 11a-2. Then, the OSC signal (at the wavelength of 1,310 nm) is inputted into an O/E unit (which is arranged in a stage following the optical filter 11a-2 and not shown), and monitoring processing is performed.

In addition, when the optical filter 11b-1 receives the main signals, the optical filter 11b-1 allows main signals in only one of the channels at a predetermined wavelength pass through the optical filter 11b-1, and reflects the remaining main signals in the other (n−1) channels. When the optical filter 11b-2 receives the reflected main signals in the (n−1) channels, the optical filter 11b-2 allows main signals in only one of the (n−1) channels at another predetermined wavelength pass through the optical filter 11b-2, and reflects the remaining main signals in the other (n−2) channels. Thereafter, similar operations are performed, so that main signals in the channels at predetermined wavelengths are separated.

Further, the optical filters 11b-1 through 11b-n have such a loss characteristic (weighted loss levels) at the predetermined wavelengths as to compensate for the WDL caused by transmission through the optical transmission line F. Therefore, there are no differences among the levels of signals in the different channels which are outputted from the optical filters 11b-1 through 11b-n, i.e., the reception levels in the different channels are equalized.

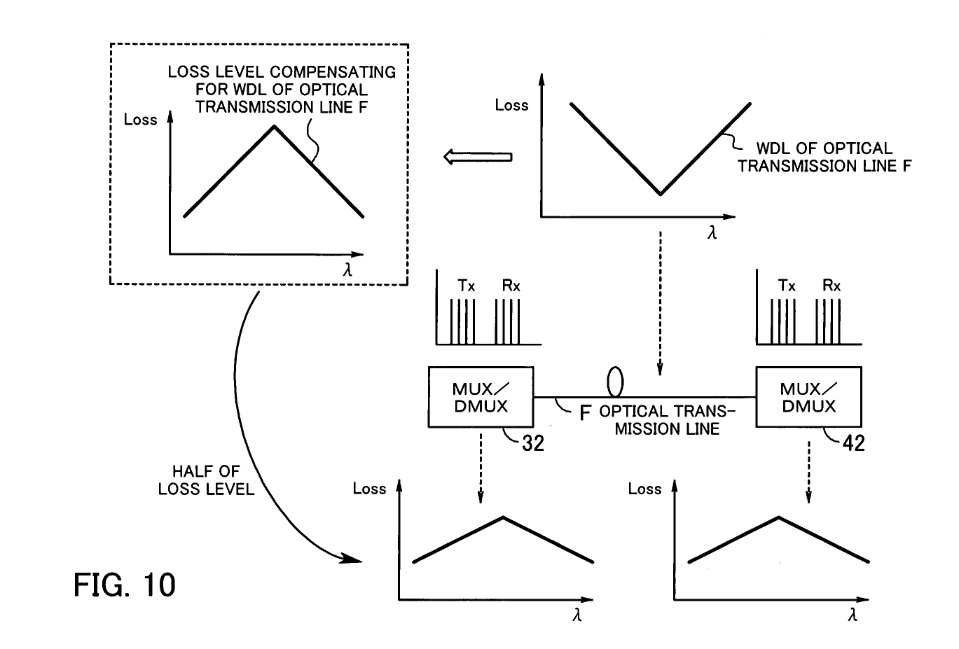

However, since there are a plurality of possible patterns of a loss compensation map which compensates for the WDL, the receiver is not necessarily required to have a loss characteristic which fully compensates for the WDL of the optical transmission line F. The loss compensation map on the receiver side will be explained later with reference to FIGS. 10 to 12.

Next, operations for wavelength multiplexing are explained below. In the following explanations, it is assumed that main signals in n channels arranged in a wavelength range used in CWDM and an OSC signal arranged on the shorter wavelength side (e.g., at the wavelength of 1,330 nm) of the wavelength range used in CWDM are wavelength multiplexed, and the wavelength-multiplexed signal is transmitted.

When the optical filter 11b-n receives a signal in the channel number chn at a predetermined wavelength from the inside of the optical transmission device, the optical filter 11b-n allows the signal in the channel number chn pass through the optical filter 11b-n, and sends the signal in the channel number chn to the optical filter 11b-(n−1). When the optical filter 11b-(n−1) receives a signal in the channel number ch(n-1) at another predetermined wavelength from the inside of the optical transmission device, the optical filter 11b-(n−1) allows the signal in the channel number ch(n−1) pass through the optical filter 11b-(n−1), reflects the signal in the channel chn sent from the optical filter 11b-n, and sends the signals in the channels chn and ch(n−1) to the optical filter 11b-(n−2). Thereafter, similar operations are performed by the optical filters 11b-(n−2) through 11b-1, so that a wavelength-multiplexed signal in which main signals in the n channels are multiplexed is sent from the optical filter 11b-1 to the optical filter 11a-1.

In the above case, the optical filters 11b-1 through 11b-n also have loss levels at the respectively corresponding wavelengths so as to realize a loss characteristic which compensates for the WDL which will occur when the above wavelength-multiplexed signal is transmitted through the optical transmission line F. The loss compensation map on the transmitter side will also be explained later with reference to FIGS. 10 to 12.

When the optical filter 11a-2 receives an OSC signal which has a wavelength of 1,330 nm and is generated by an E/O unit (which is arranged in a stage preceding the optical filter 11a-2 and not shown), the optical filter 11a-2 reflects the OSC signal, and sends the OSC signal to the optical filter 11a-1. The optical filter 11a-1 allows the main signals sent from the optical filter 11b-1 pass through the optical filter 11a-1, and reflects the OSC signal (at the wavelength of 1,330 nm), so that the main signals and the OSC signal are multiplexed to generate a wavelength-multiplexed signal. Then, the wavelength-multiplexed signal is transmitted through the WDM port P onto the optical transmission line F.

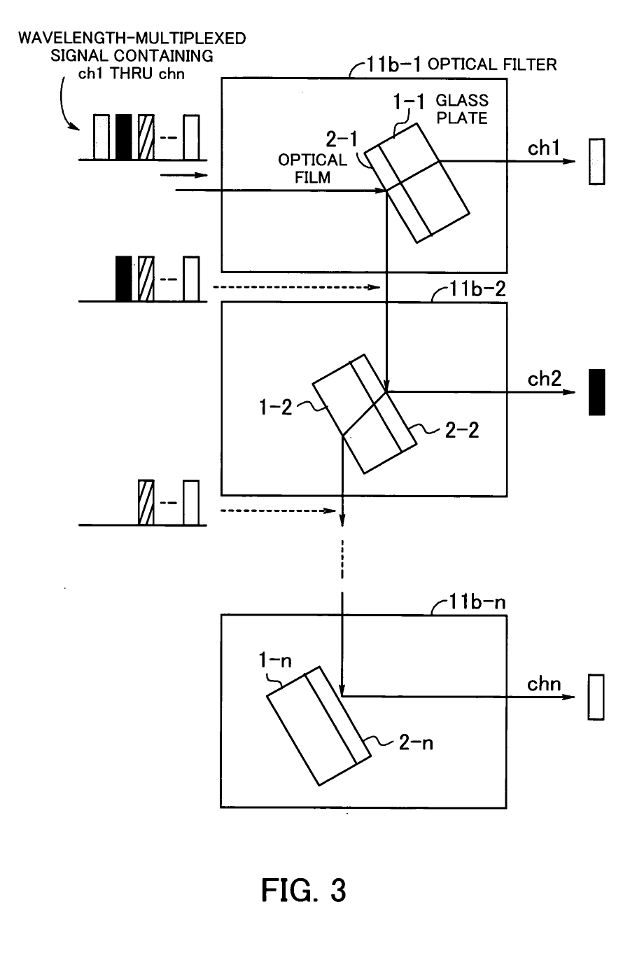

Next, a construction of each optical filter is explained below. FIG. 3 is a diagram illustrating an arrangement of optical filters. In FIG. 3, internal structures of the optical filters 11b-1 through 11b-n for main signals are illustrated. The optical filter 11b-1 has a structure in which a glass plate 1-1 is coated with an optical film 2-1. The optical film 2-1 is a dielectric multilayer film made of SiO₂, TiO₂, or the like. The optical filters 11b-2 through 11b-n also have constructions similar to the optical filter 11b-1. Further, although not shown, the optical filters 11a-1 and 11a-2 for OSC signals have structures similar to the optical filters 11b-1 through 11b-n.

Each of the optical films 2-1 through 2-n has a desired transmittance or reflectance at a predetermined wavelength at which signals are to be multiplexed or demultiplexed by a corresponding one of the optical filters 11b-l through 11b-n, so that a loss characteristic necessary for compensating for the WDL of the optical transmission line F at a predetermined wavelength is individually set in each of the optical films 2-1 through 2-n.

When a wavelength-multiplexed signal in which signals in the channels ch1 through chn are multiplexed is incident on the optical film 2-1 in the optical filter 11b-1, only signals in the channel ch1 pass through the optical film 2-1 and the glass plate 1-1, and signals in the channels ch2 through chn are reflected by the optical film 2-1 toward the optical film 2-2 in the optical filter 11b-2 so as to be incident on the optical film 2-2 in the optical filter 11b-2. Only the signals in the channel ch2 are reflected by the optical film 2-2, and signals in the other channels ch3 through chn pass through the optical film 2-2 and the glass plate 1-2. Thereafter, signals in the remaining channels ch3 through chn are separated in similar manners to the above operations.

Although the arrows in FIG. 3 show the directions of transmission of the signals before and after demultiplexing, multiplexing can be realized by exactly the same arrangement of the optical filters 11b-1 through 11b-n. The directions of transmission of the signals before and after multiplexing are exactly opposite to those of the arrows indicated in FIG. 3.

In order that the optical filters 11b-1 through 11b-n have the function of a band-pass filter, the number of dielectric layers constituting the dielectric multilayer film in each of the optical filters 11b-1 through 11b-n is about a hundred. On the other hand, in order that the optical filters 11a-1 and 11a-2 have the function of a low- or high-pass filter, the dielectric multilayer film in each of the optical filters 11a-1 and 11a-2 can be formed with about four or five dielectric layers. That is, the optical filters 11a-1 and 11a-2 can be produced at low cost.

In addition, the add/drop function for the OSC signals can be built in advance in a device realizing the wavelength multiplex/demultiplex unit 11 according to the present embodiment, and such a device can be produced at low cost. Therefore, it is possible to reduce the device size and improve serviceability.

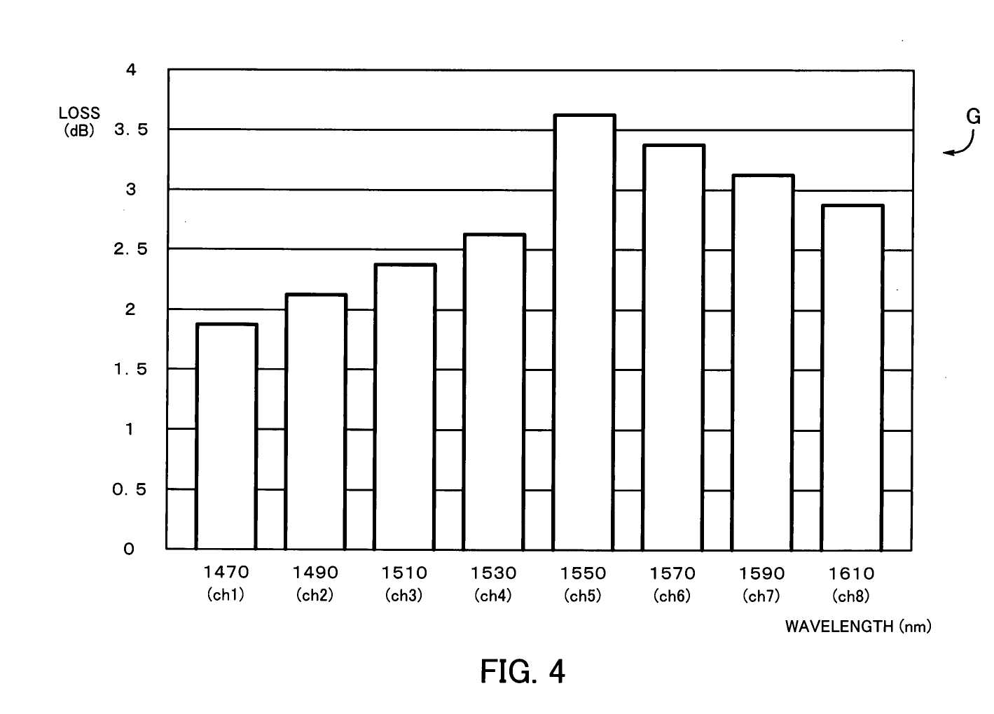

Next, the loss characteristic of the optical filters 11b-1 through 11b-n, which are arranged for compensating for the WDL of the optical transmission line F, are explained below. FIG. 4 is a diagram illustrating a loss characteristic which compensates for the WDL of the optical transmission line. In FIG. 4, the abscissa corresponds to the wavelength (nm), the ordinate corresponds to the loss (dB), and it is assumed that the wavelength range used in CWDM is 1,470 to 1,610 nm, eight wavelengths arranged at intervals of 20 nm are allocated to eight channels ch1 to ch8, respectively, and optical filters 11b-1 through 11b-8 are provided in correspondence with the eight channels.

In order to compensate for the WDL of the SMF, which has a valley shape as illustrated in FIG. 15, the loss characteristic indicated by the graph G in FIG. 4 has a ridge shape. In the wavelength multiplex/demultiplex unit 11, loss levels realizing the loss characteristic indicated by the graph G in FIG. 4 are set in the respective optical filters 11b-1 through 11b-8 corresponding to the channels ch1 through ch8.

That is, lower loss levels are set to optical filters corresponding to channels at which levels of the WDL are higher, and higher loss levels are set to optical filters corresponding to channels at which levels of the WDL are lower. Since wavelength multiplexing and demultiplexing are performed by letting signals pass through the above optical filters, variations among loss levels in the eight channels arranged in the wavelength range from 1,470 to 1,610 nm are suppressed.

However, it is impossible to equalize the reception levels in the different channels by simply arranging the optical filters 11b-1 through 11b-8 in wavelength order (i.e., by simply associating the optical filters 11b-1 through 11b-8 with the channels ch1 to ch8, respectively). This is because insertion loss caused by the presence of the optical filters 11b-1 through 11b-8 is not considered.

Therefore, according to the present embodiment, influences of the insertion loss are suppressed by arranging the optical filters 11b-1 through 11b-8 so that signals pass through the optical filters 11b-1 through 11b-8 in the order indicated below.

For example, when the gradients of the WDL of first and second portions of the wavelength range have different polarities (as the WDLs indicated in FIG. 15), the optical filters 11b-1 through 11b-8 are arranged so that signals first pass through ones of the optical filters 11b-1 through 11b-8 corresponding to wavelengths in the first portion of the wavelength range (e.g., in the shorter-wavelength range in each of the WDL curves in FIG. 15 in which the gradients of the WDL curves are negative) in decreasing order of the WDL (i.e., in increasing order of loss in the wavelength multiplex/demultiplex unit 11), and thereafter through the other of the optical filters 11b-1 through 11b-8 corresponding to wavelengths in the second portion of the wavelength range (e.g., in the longer-wavelength range in each of the WDL curves in FIG. 15 in which the gradients of the WDL curves are positive) in decreasing order of the WDL (i.e., in increasing order of loss in the wavelength multiplex/demultiplex unit 11).

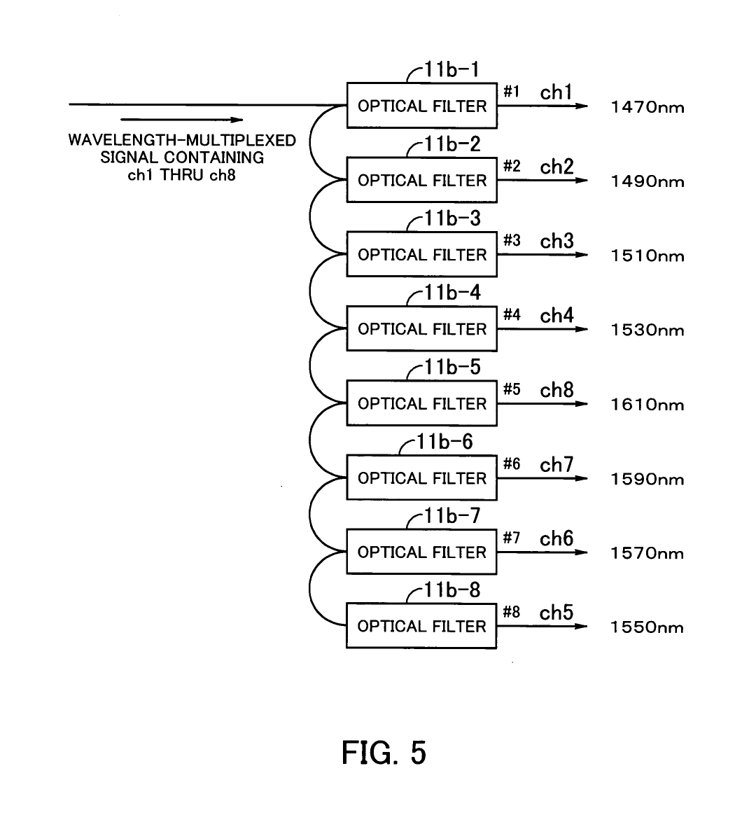

FIG. 5 is a diagram illustrating an arrangement of the optical filters for the channels based on consideration of the insertion loss. As illustrated in FIG. 5, filter setting for the channels ch1, ch2, ch3, and ch4 at the wavelengths of 1,470, 1,490, 1,510, and 1,530 nm (in increasing order of wavelength) in the shorter-wavelength range corresponding to the negative-gradient portion of the each of the WDL curves in FIG. 15 is made in the optical filters 11b-1, 11b-2, 11b-3, and 11b-4, respectively, and filter setting for the channels ch8, ch7, ch6, and ch5 at the wavelengths of 1,610, 1,590, 1,570, and 1,550 nm (in decreasing order of wavelength) in the longer-wavelength range corresponding to the positive-gradient portion of the each of the WDL curves in FIG. 15 is made in the optical filters 11b-5, 11b-6, 11b-7, and 11b-8, respectively.

That is, in the wavelength range containing the wavelengths of 1,470, 1,490, 1,510, and 1,530 nm allocated to the channels ch1, ch2, ch3, and ch4, the WDL decreases with increase in the wavelength allocated to each channel, and the loss levels L_{ch1}, L_{ch2}, L_{ch3}, and L_{ch4} constituting a loss characteristic which compensates for the WDL are set in the optical filters 11b-1, 11b-2, 11b-3, and 11b-4. The loss levels L_{ch1}, L_{ch2}, L_{ch3}, and L_{ch4} satisfy the following relationship.
L_{ch1}<L_{ch2}<L_{ch3}<L_{ch4}

In the above arrangement of the optical filters 11b-1, 11b-2, 11b-3, and 11b-4, every time an optical signal is reflected by one of the optical filters 11b-1, 11b-2, 11b-3, and 11b-4, insertion loss of the optical filter is added to the total loss occurring in the optical signal. However, since the WDL decreases with increase in the wavelength allocated to each of the channels ch1, ch2, ch3, and ch4, it is considered that the influence of accumulated insertion loss becomes small. Therefore, the channels ch1, ch2, ch3, and ch4 are respectively assigned to the optical filters 11b-1, 11b-2, 11b-3, and 11b-4.

On the other hand, in the wavelength range containing the wavelengths of 1,610, 1,590, 1,570, and 1,550 nm allocated to the channels ch8, ch7, ch6, and ch5, the WDL increases with increase in the wavelength allocated to each channel. Therefore, if the channels ch5, ch6, ch7, and ch8 are respectively assigned to the optical filters 11b-5, 11b-6, 11b-7, and 11b-8, the influence of accumulated insertion loss become unignorable. Thus, the channels ch5, ch6, ch7, and ch8 are assigned to the optical filters 11b-5, 11b-6, 11b-7, and 11b-8 in decreasing order of the WDL. That is, the channels ch8, ch7, ch6, and ch5 are respectively assigned to the optical filters 11b-5, 11b-6, 11b-7, and 11b-8.

In addition, the loss levels L_{ch5}, L_{ch6}, L_{ch7}, and L_{ch8} constituting the loss characteristic which compensates for the WDL are set in the optical filters 11b-5, 11b-6, 11b-7, and 11b-8. The loss levels L_{ch5}, L_{ch6}, L_{ch7}, and L_{ch8} satisfy the following relationship.
L_{ch8}<L_{ch7}<L_{ch6}<L_{ch5}

As explained above, according to the present embodiment, weight setting for realizing a loss characteristic which compensates for the WDL of an optical transmission line F is made in the optical filters 11b-1 through 11b-n, and the channels are assigned to the optical filters in such a manner that the influences of accumulated insertion loss caused by the presence of the optical filters are suppressed. Thus, it is possible to efficiently compensate for differences among levels of loss caused in different channels by transmission of a wavelength-multiplexed signal.

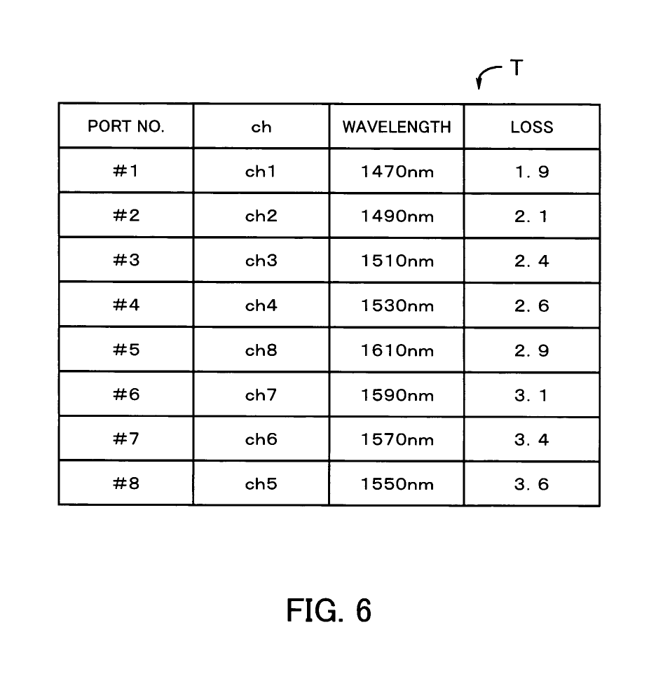

FIG. 6 is a diagram indicating correspondences between the port numbers of the optical filters and the channels. The table T illustrated in FIG. 6 has fields of the port numbers “Port No.” of the optical filters 11b-1 through 11b-8, the channel numbers “ch”, the wavelengths “Wavelength”, and the loss levels “Loss” set in the optical filters 11b-1 through 11b-8 (the loss-compensation values illustrated in FIG. 4).

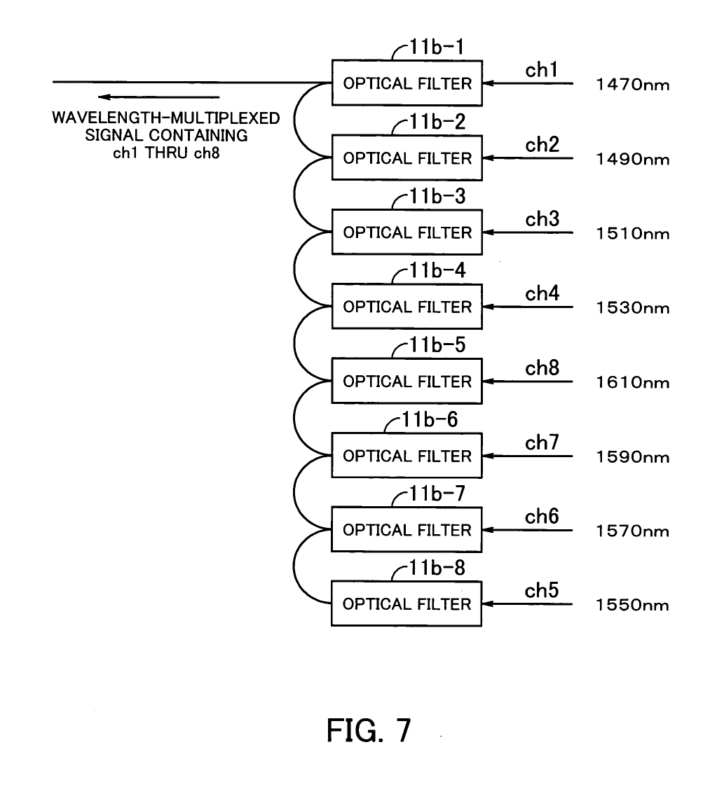

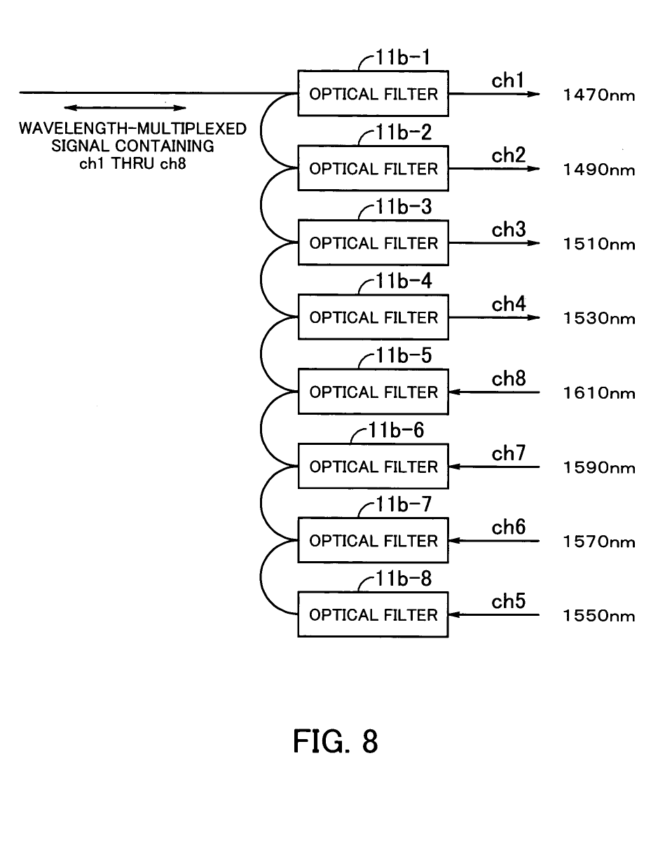

Although each of the ports in the construction of FIG. 5 is used for both of wavelength demultiplexing and multiplexing, alternatively, it is possible to use all of the ports for wavelength multiplexing, or divide the ports into two groups each of which is exclusively used for wavelength demultiplexing or wavelength multiplexing. FIG. 7 is a diagram illustrating a construction in which all ports are used for wavelength multiplexing. FIG. 8 is a diagram illustrating a construction in which ports are divided into two groups each of which is exclusively used for wavelength demultiplexing or wavelength multiplexing. Since the operations of the constructions of FIGS. 7 and 8 are similar to the construction of FIG. 5, the operations of the constructions of FIGS. 7 and 8 are not explained.

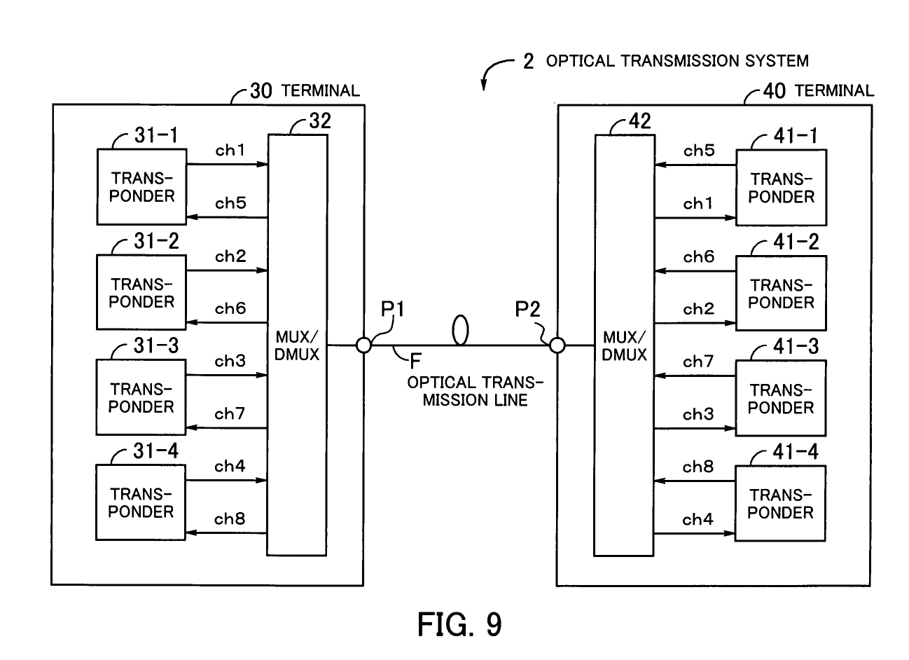

Next, an optical transmission system using the optical transmission device 10 according to the present invention is explained below. FIG. 9 is a diagram illustrating a construction of such an optical transmission system. In FIG. 9, the optical transmission system 2 comprises a terminal 30 (corresponding to the first optical transmission device in claim 5) and a terminal 40 (corresponding to the second optical transmission device in claim 5), and optical transmission is performed through the optical transmission line F in such a manner that a small number of channels are arranged in a wide wavelength range as in CWDM.

The terminal 30 comprises a WDM port P1, transponders 31-1 through 31-4, and a multiplexer/demultiplexer (MUX/DMUX) 32 (corresponding to the first wavelength multiplex/demultiplex unit in claim 5). The terminal 40 comprises a WDM port P2, transponders 41-1 through 41-4, and a multiplexer/demultiplexer (MUX/DMUX) 42 (corresponding to the second wavelength multiplex/demultiplex unit in claim 5). Each of the MUX/DMUX 32 and the MUX/DMUX 42 has the functions of the aforementioned wavelength multiplex/demultiplex unit 11.

Operations of transmitting a wavelength-multiplexed signal from the terminal 30 to the terminal 40 are explained below.

First, the transponders 31-1 through 31-4 perform bandwidth conversion of optical signals in channels ch1 through ch4 having different wavelengths and being transmitted from the tributary side so that the bandwidths of the optical signals in the channels ch1 through ch4 are adapted for WDM, and send the converted optical signals to the MUX/DMUX 32. The MUX/DMUX 32 multiplexes the converted optical signals into a wavelength-multiplexed signal, and transmits the wavelength-multiplexed signal to the terminal 40 through the optical transmission line F.

The terminal 40 receives from the WDM port P2 the wavelength-multiplexed signal transmitted through the optical transmission line F, and the MUX/DMUX 42 demultiplexes the wavelength-multiplexed signal into demultiplexed signals in the channels ch1 through ch4 at different wavelengths, and sends the demultiplexed signals in the channels ch1 through ch4 to the transponders 41-1 through 41-4, respectively. The transponders 41-1 through 41-4 perform bandwidth conversion of the demultiplexed signals in the channels ch1 through ch4 so that the bandwidths of the demultiplexed signals in the channels ch1 through ch4 are adapted to the tributary side, and send the converted demultiplexed signals to the tributary side.

Since operations of transmitting a wavelength-multiplexed signal from the terminal 40 to the terminal 30 are similar to the above operations of transmitting a wavelength-multiplexed signal from the terminal 30 to the terminal 40, the operations of transmitting a wavelength-multiplexed signal from the terminal 40 to the terminal 30 are not explained.

FIGS. 10 to 12 are diagrams illustrating examples of loss-compensation patterns (loss-compensation maps) for compensating for the WDL of the optical transmission line F in the optical transmission system 2.

In the case of FIG. 10, halves of loss levels realizing a loss characteristic which compensates for the WDL of the optical transmission line F are set at respective wavelengths in each of the MUX/DMUX 32 and the MUX/DMUX 42.

According to the above configuration, for example, when a wavelength-multiplexed signal containing signals in the channels ch1 through ch4 is transmitted from the MUX/DMUX 32 through the entire optical transmission line F, and the terminal 40 receives the wavelength-multiplexed signal, halves of the variations in the WDL of the optical transmission line F in the wavelength-multiplexed signal are already compensated for. Thereafter, the remaining halves of the variations in the WDL are compensated for by the MUX/DMUX 42. Since the WDL of the SMF is compensated for by the sum of the loss characteristics set in the MUX/DMUX 32 and the MUX/DMUX 42, it is possible to equalize the total loss levels in the different channels without causing excessive loss compensation (over compensation).

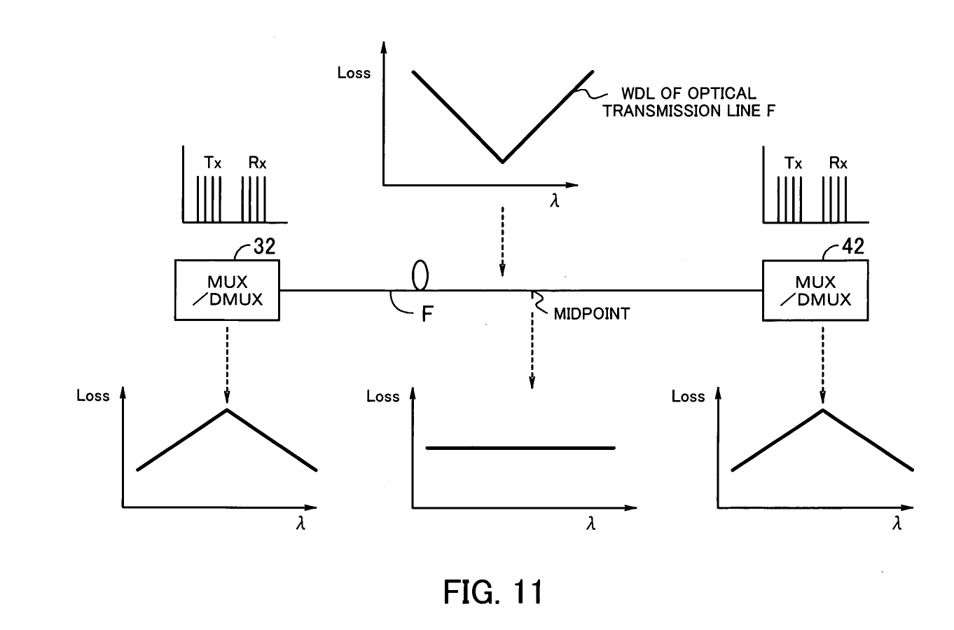

In the case of FIG. 11, a first loss characteristic which compensates for a WDL in a first section of the optical transmission line F between the MUX/DMUX 32 and the midpoint of the optical transmission line F is set in the MUX/DMUX 32 (so that the wavelength dependence of the loss becomes flat at the midpoint), and a second loss characteristic which compensates for a WDL in a second section of the optical transmission line F between the midpoint of the optical transmission line F and the MUX/DMUX 42 is set in the MUX/DMUX 42.

According to the above configuration, at the midpoint of the optical transmission line F, for example, a WDL which occurs in a wavelength-multiplexed signal containing signals in the channels ch1 through ch4 and being transmitted from the MUX/DMUX 32 to the midpoint is compensated for by the first loss characteristic set in the MUX/DMUX 32, and becomes flat. Thereafter, when the wavelength-multiplexed signal is transmitted from the midpoint to the MUX/DMUX 42 through optical transmission line F, another WDL occurs in the wavelength-multiplexed signal. However, the WDL caused by transmission from the midpoint to the MUX/DMUX 42 is compensated for by the second loss characteristic set in the MUX/DMUX 42. Since the WDLs occurring in the first and second sections are respectively compensated for by the first and second loss characteristics set in the MUX/DMUX 32 and the MUX/DMUX 42, it is possible to equalize the total loss levels in the different channels without causing excessive loss compensation (over compensation).

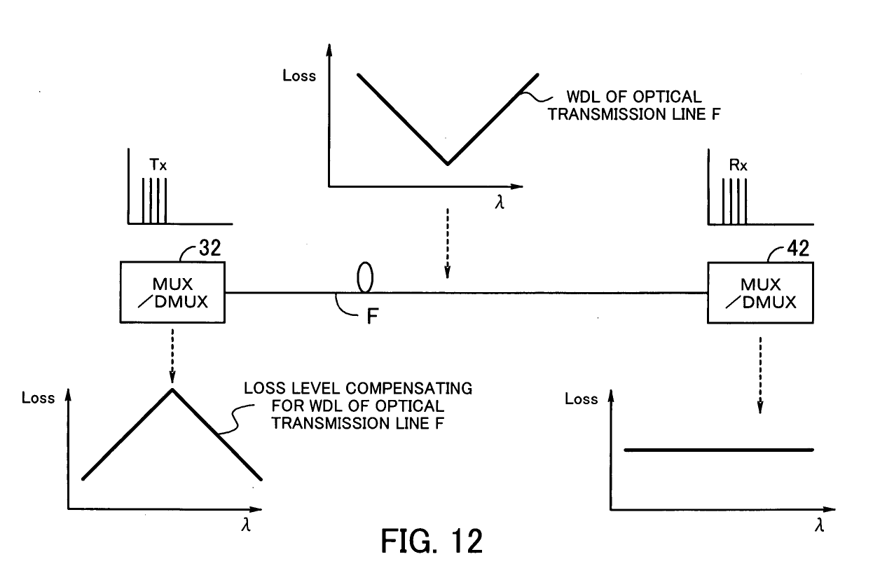

In the case of FIG. 12, first a loss characteristic which compensates for the WDL of the optical transmission line F is set in the multiplexer portion of each of the MUX/DMUX 32 and the MUX/DMUX 42, and a flat loss characteristic (in which identical loss levels are set for the different channels) is set in the demultiplexer portion of each of the MUX/DMUX 32 and the MUX/DMUX 42.

According to the above configuration, for example, when a wavelength-multiplexed signal containing signals in the channels ch1 through ch4 is transmitted from the MUX/DMUX 32 through optical transmission line F, and the terminal 40 receives the wavelength-multiplexed signal, the WDL of the optical transmission line F in the wavelength-multiplexed signal is already compensated for. Thereafter, the wavelength-multiplexed signal passes through the MUX/DMUX 42 in which the flat loss characteristic is set. Since the WDL of the SMF is compensated for by the loss characteristics set in the multiplexer portion of each of the MUX/DMUX 32 and the MUX/DMUX 42, it is possible to equalize the total loss levels in the different channels without causing excessive loss compensation (over compensation).

Although not shown, alternatively, it is possible to set a loss characteristic which compensates for the WDL of the optical transmission line F in the demultiplexer portion of each of the MUX/DMUX 32 and the MUX/DMUX 42, and a flat loss characteristic in the multiplexer portion of each of the MUX/DMUX 32 and the MUX/DMUX 42.

As explained above, according to the present invention, the WDL of the optical transmission line is compensated for by utilizing the loss characteristic of the wavelength multiplex/demultiplex unit (MUX/DMUX) which is used in optical transmission and reception. Thus, it is possible to secure a dynamic range in a wide bandwidth. In addition, quality in optical transmission is improved, and long-distance communication is enabled, in an optical transmission system in which channels are arranged in a wide wavelength range. Although the transmission distances in the conventional CWDM are about 50 or 60 km, a measurement of a transmittable distance achieved by the optical transmission device according to the present invention shows that the optical transmission device according to the present invention enables transmission over about 100 km without repeater amplifiers.

Although the present invention is applied to CWDM in the above explanations, the present invention can also be applied to WWDM (Wide WDM), in which information is transmitted by using a smaller number of wavelengths than CWDM. In addition, application of the present invention is not limited to unrepeated systems such as CWDM or WWDM, and the present invention can be widely applied to any optical communication systems in which compensation for transmission loss is required.

As explained above, the optical transmission device according to the present invention has a loss characteristic compensating for a wavelength-dependent loss characteristic of an optical transmission line, and has such a construction as to perform one or both of wavelength demultiplexing of a signal received through a WDM port and wavelength multiplexing for outputting a signal through the WDM port, and equalize loss levels in different channels by compensating for differences among the different channels in loss caused by transmission of a wavelength-multiplexed signal. Thus, it is possible to efficiently suppress differences among the levels of loss caused by optical fiber transmission, and improve quality in optical transmission.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. An optical transmission device for performing transmission of an optical signal, comprising:
a WDM port as a port for transmission and reception of a wavelength-multiplexed signal; and
a wavelength multiplex/demultiplex unit which has a loss characteristic compensating for a wavelength-dependent loss characteristic of an optical transmission line, performs at least one of wavelength demultiplexing of a signal received through said WDM port and wavelength multiplexing for outputting a signal through the WDM port, and suppresses differences among different channels in loss caused by transmission of a wavelength-multiplexed signal so as to equalize loss levels in the different channels in the wavelength-multiplexed signal.

2. The optical transmission device according to claim 1, wherein said wavelength multiplex/demultiplex unit comprises a plurality of optical filters which are provided in correspondence with a plurality of wavelengths, are daisy-chain connected, and have a loss characteristic weighted at the plurality of wavelengths in correspondence with said wavelength-dependent loss characteristic, and each of the plurality of optical filters has a function of a band-pass filter and an identical insertion loss.

3. The optical transmission device according to claim 2, wherein when said wavelength-dependent loss characteristic shows decrease in loss with increase in wavelength in a first wavelength range and increase in loss with increase in wavelength in a second wavelength range, said plurality of optical filters are arranged in such a manner that signals to be demultiplexed first pass through ones of said plurality of optical filters corresponding to wavelengths in one of said first and second wavelength ranges in decreasing order of said wavelength-dependent loss characteristic, and then through other ones of said plurality of optical filters corresponding to wavelengths in another of said first and second wavelength ranges in decreasing order of said wavelength-dependent loss characteristic.

4. The optical transmission device according to claim 1, wherein said wavelength multiplex/demultiplex unit further comprises an optical filter through which separation or insertion of a signal for maintenance control is performed.

5. An optical transmission system for performing transmission of an optical signal, comprising:
an optical transmission line as a transmission medium of a wavelength-multiplexed signal;
a first optical transmission device being connected to an end of said optical transmission line, and comprising a first wavelength multiplex/demultiplex unit which has a loss characteristic compensating for a wavelength-dependent loss characteristic of the optical transmission line, and performs at least one of wavelength demultiplexing of an optical signal and wavelength multiplexing of optical signals; and
a second optical transmission device being connected to another end of said optical transmission line, and comprising a second wavelength multiplex/demultiplex unit which has a loss characteristic compensating for said wavelength-dependent loss characteristic of the optical transmission line, and performs at least one of wavelength demultiplexing of an optical signal and wavelength multiplexing of optical signals.

6. The optical transmission system according to claim 5, wherein each of said first and second wavelength multiplex/demultiplex units comprises a plurality of optical filters which are provided in correspondence with a plurality of wavelengths, are daisy-chain connected, and have a loss characteristic weighted at the plurality of wavelengths in correspondence with said wavelength-dependent loss characteristic, and each of the plurality of optical filters has a function of a band-pass filter and an identical insertion loss.

7. The optical transmission system according to claim 6, wherein when said wavelength-dependent loss characteristic shows decrease in loss with increase in wavelength in a first wavelength range and increase in loss with increase in wavelength in a second wavelength range, said plurality of optical filters in each of said first and second wavelength multiplex/demultiplex units are arranged in such a manner that signals to be demultiplexed first pass through ones of said plurality of optical filters corresponding to a plurality of wavelengths in one of said first and second wavelength ranges in decreasing order of said wavelength-dependent loss characteristic, and then through other ones of said plurality of optical filters corresponding to a plurality of wavelengths in another of said first and second wavelength ranges in decreasing order of said wavelength-dependent loss characteristic.

8. The optical transmission system according to claim 5, wherein each of said first and second wavelength multiplex/demultiplex units further comprises an optical filter through which separation or insertion of a signal for maintenance control is performed.

9. The optical transmission system according to claim 5, wherein when said first wavelength multiplex/demultiplex unit performs wavelength multiplexing, and said second wavelength multiplex/demultiplex unit performs wavelength demultiplexing, each of said first and second wavelength multiplex/demultiplex units has a loss characteristic which compensates for half of said wavelength-dependent loss characteristic so that differences among different channels in loss caused by transmission of a wavelength-multiplexed signal are suppressed, and loss levels in the different channels in the wavelength-multiplexed signal are equalized.

10. The optical transmission system according to claim 5, wherein when said first wavelength multiplex/demultiplex unit performs wavelength multiplexing, and said second wavelength multiplex/demultiplex unit performs wavelength demultiplexing, said first wavelength multiplex/demultiplex unit has a first loss characteristic which compensates for a first wavelength-dependent loss characteristic of a first section of the optical transmission line between said first optical transmission device and a midpoint of the optical transmission line, and said second wavelength multiplex/demultiplex unit has a second loss characteristic which compensates for a second wavelength-dependent loss characteristic of a second section of the optical transmission line between said midpoint and said second optical transmission device, so that differences among different channels in loss caused by transmission of a wavelength-multiplexed signal are suppressed, and loss levels in the different channels in the wavelength-multiplexed signal are equalized.

11. The optical transmission system according to claim 5, wherein when said first wavelength multiplex/demultiplex unit performs wavelength multiplexing, and said second wavelength multiplex/demultiplex unit performs wavelength demultiplexing, said first wavelength multiplex/demultiplex unit has a loss characteristic which compensates for said wavelength-dependent loss characteristic of the optical transmission line, and said second wavelength multiplex/demultiplex unit has a flat loss characteristic which shows identical loss levels at all wavelengths used in transmission, so that differences among different channels in loss caused by transmission of a wavelength-multiplexed signal are suppressed, and loss levels in the different channels in the wavelength-multiplexed signal are equalized.

12. The optical transmission system according to claim 5, wherein when said first wavelength multiplex/demultiplex unit performs wavelength multiplexing, and said second wavelength multiplex/demultiplex unit performs wavelength demultiplexing, said first wavelength multiplex/demultiplex unit has a flat loss characteristic which shows identical loss levels at all wavelengths used in transmission, and said second wavelength multiplex/demultiplex unit has a loss characteristic which compensates for said wavelength-dependent loss characteristic of the optical transmission line, so that differences among different channels in loss caused by transmission of a wavelength-multiplexed signal are suppressed, and loss levels in the different channels in the wavelength-multiplexed signal are equalized.

13. A wavelength multiplexing coupler for performing wavelength multiplexing, comprising:
a plurality of input ports through which light having a plurality of different wavelengths is received;
a multiplexing unit which has losses corresponding to said plurality of different wavelengths of said light received through said plurality of input ports, and multiplexes the light received through the plurality of input ports; and
an output port through which the light multiplexed by said multiplexing unit is outputted onto an optical transmission line.

14. The wavelength multiplexing coupler according to claim 13, wherein said optical transmission line has a wavelength-dependent loss characteristic, and said losses which the multiplexing unit has correspond to the wavelength-dependent loss characteristic of the optical transmission line.

15. A wavelength demultiplexing coupler for performing wavelength demultiplexing, comprising:
an input port through which wavelength-multiplexed light is received from an optical transmission line, where light having a plurality of different wavelengths is multiplexed in the wavelength-multiplexed signal;
a demultiplexing unit which has losses corresponding to said plurality of different wavelengths of said wavelength-multiplexed light received through the input port, and demultiplexes the wavelength-multiplexed light received through the input port, into demultiplexed light; and
a plurality of output ports through which said demultiplexed light is outputted.

16. The wavelength demultiplexing coupler according to claim 15, wherein said optical transmission line has a wavelength-dependent loss characteristic, and said losses which the demultiplexing unit has correspond to the wavelength-dependent loss characteristic of said optical transmission line.

17. A wavelength multiplexing-and-demultiplexing coupler for multiplexing and demultiplexing wavelengths, comprising:
a first input-and-output port through which light having a plurality of first different wavelengths is received from an optical transmission line, and light having a plurality of second different wavelengths is outputted onto the optical transmission line;
a multiplexing-and-demultiplexing unit which has one of first loss corresponding to said plurality of first different wavelengths and second loss corresponding to said plurality of second different wavelengths, demultiplexes said plurality of first different wavelengths received through said first input-and-output port, and multiplexes said plurality of second different wavelengths to be outputted through said first input-and-output port; and
a plurality of second input-and-output ports through which light to be multiplexed is received, and demultiplexed light is outputted.

18. The wavelength multiplexing-and-demultiplexing coupler according to claim 17, wherein said optical transmission line has a wavelength-dependent loss characteristic, and said one of the first loss and the second loss corresponds to the wavelength-dependent loss characteristic of the optical transmission line.
